(19) United States
(12) Patent Application Publication
(10) Pub. No.: US 2004/0131769 A1
(43) Pub. Date: Jul. 8, 2004

(54) Method for restoring a plastics surface

(76) Inventor: George Bernard Saxon, Auckland (NZ)

Correspondence Address: YOUNG & THOMPSON, 745 SOUTH 23RD STREET 2ND FLOOR, ARLINGTON, VA, 22202

(21) Appl. No.: 10/472,894

(22) PCT Filed: Mar. 27, 2002
(86) PCT No.: PCT/NZ02/00051

(30) Foreign Application Priority Data
Mar. 29, 2001 (NZ) 510798

(51) Int. Cl. B05D 1/36; B05D 1/02

(52) U.S. Cl. 427/140; 427/421; 427/402

(57) ABSTRACT

A method for repair of a defect in a thermoset decorative laminate comprises (a) debridement of damaged material to below the level of the adjacent surface, (b) replacement of the lost mass with layers of cyanoacrylate, or a two-part filler for deep defects, (c) surface flattening, (d) colouring and patterning of the surface, and (e) coating the surface of the defect with a material giving a similar texture, so that the adjacent surface appearance is matched. Applications include kitchen bench repairs where the surface has been damaged by heat, and defects in other non-metallic surfaces.

### FIELD

The present invention relates to restoration of lost volume and restoration of original colour, pattern and texture of damaged areas upon plastic surfaces, such as bench tops, baths, and the like. The invention is particularly relevant to restoration of decorative thermoset plastic laminates.

### BACKGROUND

In a kitchen within a house, for example, a bench working area carrying a surface of a laminate comprised of polymerised phenolic resin impregnated into many layers of Kraft paper is commonly selected and a classic example is “Formica” (CM) which was first made in 1913 There are now a number of equivalents. The working surface may be decorated with a variety of patterns in a variety of colours usually printed onto to an uppermost layer of paper buried just under the surface. The relative hardness and stability of the material leads persons to think that it is indestructible. A hot frying pan or a clothes iron, if placed on the surface, will quickly damage the surface leaving at least an unsightly brownish patch and possibly an area where the surface is completely disrupted. This damage may be repaired by replacement of the entire bench. Another is to superimpose a wooden surface or a ceramic tile on the burnt area and imply that the addition had always been intended. This cheaper “cure” prevents repetition and is favoured by insurance companies. A hot wax repair procedure is known, but is only a short-term solution, has a dull surface, and is liable to be melted.

Within the patent literature, there are a number of patents directed to methods for restoring plastic surfaces usually transparent windows, and one relating to restoring the colour of a vinyl surface (U.S. Pat. No. 5,785,766 Davis) who makes use of fluorescent pigments in order to lift the apparent brightness of an old vinyl surface, but none combine a colour and pattern restoration technique with a plastics restoration method applicable to decorative laminates. In detail, Zuk, U.S. Pat. No. 4,301,193 teaches a portable process for restoring plastic windows simply involving abrading then polishing out the scratches then optionally applying a liquid silicone formulation with optional additives to the surface. Norville, U.S. Pat. No. 5,407,615 adds to Zuk by specifying particular polishing agents. Janssen et al U.S. Pat. No. 6,180,245 repairs scratches by in effect gluing onto the damaged surface of the laminate a second, undamaged sheet and claims good optical performance. Black et al U.S. Pat. No. 6,306,508 adds material similarly; using a polyurethane film polymerised in situ. The material is selected in part for having a refractive index within the range for glass. Foster, U.S. Pat. No. 5,194,293 discloses a method for restoring a weathered plastics surface by cleaning and polishing away all major imperfections, then applying a layer of a selected and compatible ultra-violet curable material over the surface. The inventor uses a selection from a range of commercially provided UV curable materials incorporating photosensitive compounds capable of starting a polymerising or cross-linking activity. Leach et al, U.S. Pat. No. 5,470,609 describes an invention characterised in that materials normally used in powder coating are placed in or on a defective area particularly on a fibreglass article, and then heated to cause setting, then abraded or polished back to a compatible surface. None of the above teach towards the present invention.

The problem to be solved might be stated as “to provide a more cost-effective method for repairing and colouring a damaged area within (usually) a plastics surface, so that the repair is substantially invisible”.

### OBJECT

It is an object of this invention to provide a method for repairing a damaged area within a patterned, coloured plastics surface, or at least to provide the public with a useful choice.

### STATEMENT OF INVENTION

In a first broad aspect the invention provides a method for repairing a defect in a surface; the method including replacement of lost or damaged mass (if any) and then restoration of the visual appearance of the surface of the repaired defect so that a close match is obtained with an adjacent surface, wherein the method includes the stages of

a) removing the damaged material at least beneath the plane of the adjacent surface so that only undamaged material remains within the defect,

b) optionally cutting a bevel around the outer edges of the debrided area,

c) filling the defect with a mass of a selected polymerisable material, until the surface of the mass protrudes slightly above the adjacent surface,

d) reducing the height of the surface of the filled defect by scraping and/or abrasion, so that the surface plane is slightly below the plane of the adjacent surface,

e) restoring the colour and pattern by repeatedly (i) applying at least one selected pigment in a similar colour and pattern to that of the adjacent surface over the filled defect, then (ii) spraying a selected sealing material over the pigment, until the colour and pattern are substantially matched, and

f) spraying a sealing material selected in relation to drying texture over the uppermost layer of pigment so that the texture of the repaired defect matches the texture of the adjacent surface.

In a first related aspect, the mass of polymerisable material used to fill the defect comprises at least one layer of polymerised plastic.

Preferably the polymerised plastic is a cyanoacrylate.

Alternatively (for larger or deep defects) the mass of polymerisable material used to fill the defect comprises a two-part putty.

In a second related aspect, the selected pigment comprises a suspension of coloured particles in at least one organic solvent.

Preferably the solvent includes at least one of: toluene, methyl ethyl ketone, and methyl iso butyl ketone.

In a third related aspect, the selected sealing material comprises a fixture of at least one selected polymerisable monomer having a known texture upon drying, and a selected polymerising agent conferring a known curing rate upon the mixture.

Preferably the sealing material is applied to the surface by a spraying process.

In a fourth related aspect, he selected pigment is taken up within a brush having a low holding capacity and applied to the surface of the filled defect by repeatedly touching the brush to the surface.

Preferably the brush comprises an end of a pipe cleaner and preferably the fibres are cotton.

In a second broad aspect, the invention provides a kit of equipment comprising the tools and materials for use in performing the method as previously described in this section.

### PREFERRED EMBODIMENT

The description(s) of the invention to be provided herein is/are given purely by way of example and is/are not to be taken in any way as limiting the scope or extent of the invention.

### DRAWINGS

FIGS. 1 to 5: show the process of restoration of mass of a burnt area on a thermoset laminate surface, during the first part of the repair process.

FIG. 6: shows use of skewed holes to “key” a mass of two-part putty (e.g. Selley's “Knead-it”) into a deep defect so that the putty is held in place.

FIG. 7: shows use of a pipe cleaner to add pigment on to a surface.

FIG. 8: shows spraying of a surface texture composition over the defect.

This invention comprises a generalised repair process applicable to surfaces composed of a variety of types of plastic. The invention is capable of providing a surface of a desired texture, degree of gloss, colour and pattern, and is optionally capable of replacing a damaged mass of plastic. The most common application is in the repair of “Formica” C1M) (or equivalent) thermoset laminated decorative bench tops which have been burnt by contact with hot household implements although scratching, rubbing, impact damage or intentional modification can also leave defects.

In principle the invention lies in a combination of (A) selection of appropriate plastics materials, (B) the devising of suitable colouring and finishing agents, and (C) development of hand and/or machine techniques and procedures for applying these materials to a surface to be repaired The method commences by debriding the damaged material, bevelling around the outer edges of the debrided area, filling the debrided area with a filler, and optionally a two-pot putty in order to fill bigger defects, restoring the colour and pattern by painting a matching pattern over the replaced mass using compatible and colour-matched pigments, and then restoring the surface so that it has the same appearance as the surrounding surface.

TABLE OF MATERIALS USED

| | Example | |
|---|---|---|
| | commercial | |
| Name in text | product | Notes |
| Part I materials. | | |
| ProFill Thin | Loctite 401 | |
| ProSet | Loctite 7452 | |
| ProFill Gel | Loctite 499 | |
| ProPutty | Selley's Knead-it | A two-pot hardening |
| | (a filler) | putty. |
| Part 2 materials. | | |
| ProColour | ? Fiebing's | Formulation including |
| | Acrylic | a selected pigment |
| | Dye Pack for | suspended in a solvent, |
| | leather. | including toluene, |
| | | methyl ethyl ketone |
| | | and methyl iso-butyl |
| | | ketone |
| pipe cleaners | “Rizzla” or | Cotton fibre pipe |
| | “Moderna” | cleaners |
| | brand. | |
| ProSeal | | A customised mixture |
| | | selected from the |
| | | materials below, in |
| | | order to provide a |
| | | matching surface. |
| ProMat (A) | RSL4010 | Resene Santano |
| | | Limited 4000 range |
| ProSatin (A) | RSL4030 | Resene Santano |
| | | Limited |
| ProGloss (A) | RSL4000 | Resene Santano |
| | | Limited |
| FastCure (B) | (Extra Fast 2K | Resene Santano |
| | Primer Hardener) | Limited |
| SlowCure (B) | (General Purpose | Resene Santano |
| | 2K Hardener) | Limited |
| ProThinner | (RSL 909 Reducer) | Resene Santano |
| | | Limited |

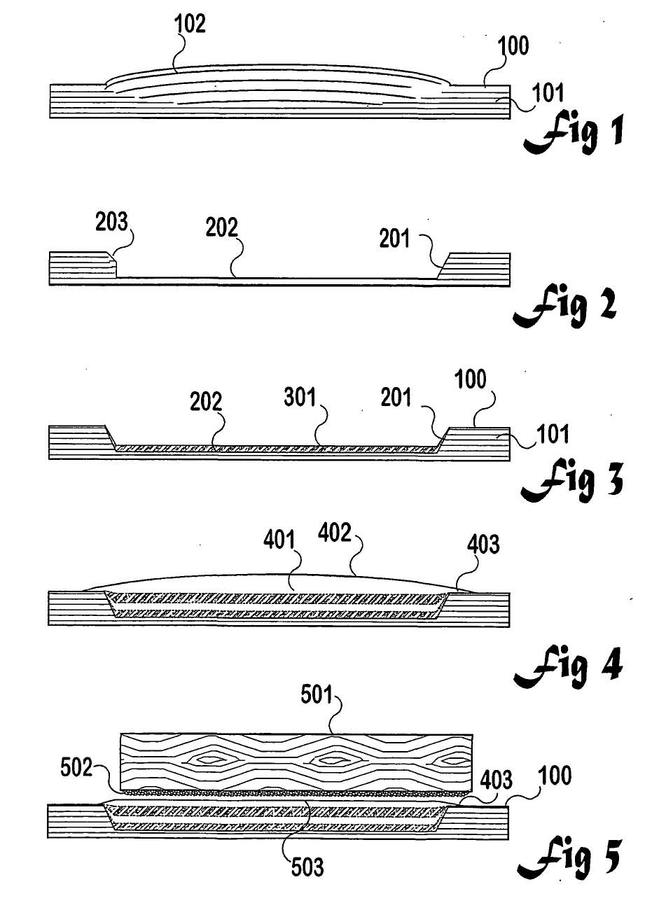

This description applies to the repair of a surface comprised of a laminate (such as ″Formica (TM) or the like) which has been damaged, for example blistered or even burnt right through the surface by a hot pot. In FIG. 1, 100 shows the exposed surface of the laminate, 101 indicates the mass of the laminated, resin-impregnated thermoset material, and 102 indicates the 120 blistered area.

PART 1: Restoration of Lost Mass Within A Surface.

For a burnt area, removal of the the main bubble of the blister exposes the brown substrate underneath. All loose or heat-damaged material must be cleared away from the area before filling can be done. For debridement, an artist's palette knife or the like can be used to slice 125 through delaminated or blistered layers of surface. A “Dremel” (TM) hand-held machining tool with a bevelling attachment fitted can grind off damaged material.

The outer edge (bordering undamaged material) should be chamfered at about 45 degrees (see FIG. 2) in order to avoid visible edges or lines in the final repair, especially in a plain coloured laminate. This is easily done with the bevelling tool, holding the Dremel at a slight angle to the surface. FIG. 2, after removal of visibly damaged material, shows at 201 the chamfered outer border and at 202 an underlying substrate of laminate lying beneath the blistered area. At the left edge f FIG. 2a second form of adequate chamfer is shown at 203.

Replacement of the mass of material is the next step. If the damage is within a flat horizontal surface, the inventor prefers to use a cyanoacrylate material termed ProFill Thin (see Table 1) to fill the deficiency. A repeated procedure of thinly covering the area with the rather fluid preparation (preferably less than 2 mm thickness), and spreading it evenly with a metal mixing pin (a chicken skewer is suitable) is followed. The activator ProSet can be used beneath the first coat especially in dry environments or to prevent wicking of the glue through pores. Excessive use of activator tends to result in a brittle fill that cracks and shrinks away from the edges. FIG. 3 shows a layer 301 of the cyanoacrylate material undergoing curing. Note that the material (at least in some applied layers) extends over the bevelled edges 201. After a curing period, further layers are added until the surface is slightly proud of the surrounding area and overlaps the whole perimeter of the chamfered edge. The bevel and the overlapping helps to eliminate the problems of fine cracks and edges appearing either now or later. FIG. 4 shows a mass 402 if this material after curing, with the separate applications indicated by hatching 401. Note that the material extends past the edges and over the laminate surface at 403.

If the surface is not horizontal, a cyanoacrylate gel is appropriate. We use ProFill Gel (See Table 1) which can be squeezed directly from the tube onto the area needing filling and spread with a palette knife. Again, a series of applications are preferred, for faster curing particularly if the area is more than 5 mm deep. If the palette knife is held sitting level with the surface to be repaired but slightly off the flat, the gel can be gently spread about as if applying butter to bread. With this material and procedure can reshape damaged corners on to benches, chipped bull noses or cracked upturns.

An activator can be applied on top to speed up the drying time of both these products but will only affect the top layer. Too thick a layer may shrink as it cures.

The inventor prefers to use ProPutty (see Table 1) for filling a deep deficiency-burn nail or screw hole or any other deep damage and let it set naturally, giving the ProPutty time to soak into any loose materials and form a solid base for a repair so that the operator can rely on the foundation when later working on the restored surface. It is preferably to construct a “key” for the ProPutty so that its mass, after setting, is locked into place. FIG. 6 shows a deep defect 601 right through the laminate 100 and into a substrate 605. Three keying holes, 602, 603 and 604 have been made into the substrate and the laminate has been chamfered. The smoothest surface is obtained if the ProPutty can set naturally but if drying time is an issue it can be sped up with an activator. Apply a small amount of the activator ProSet to harden the top layer so that it can be sanded.

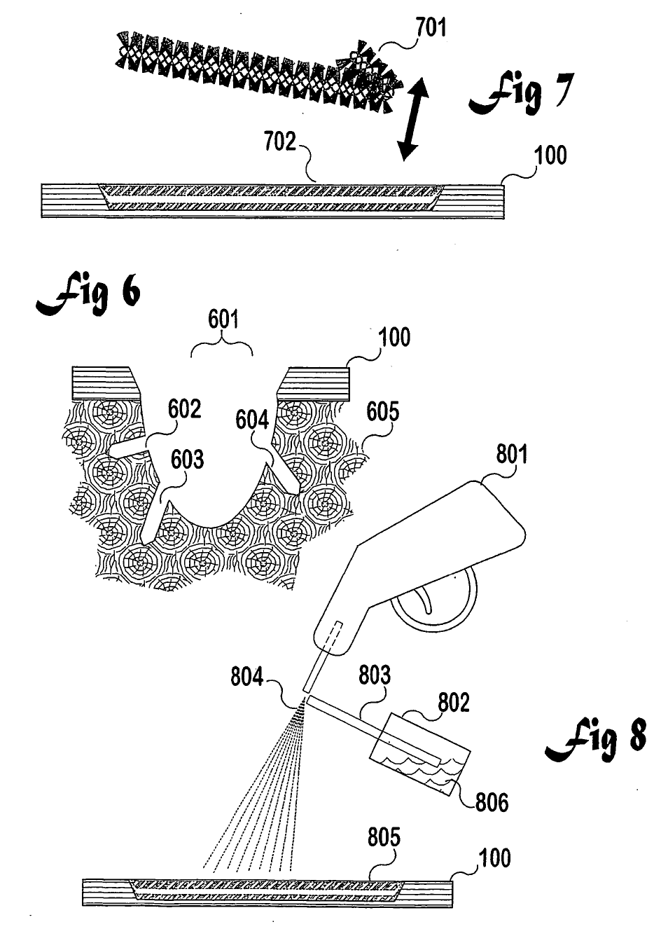

For reduction of the proud surface either scraping or sanding can be used. The sanding involves a preferably 240 grit wet and dry grade sandpaper used wet, with a gentle rubbing action, with no hand pressure over the raised area and slowly work the area down until it is flush with the rest of the bench top. A general sign that the surface is nearly level when sanding is that the surrounding decorated layer is being removed when a white border appears around the edge. (Scraping keeps the surface flat and damage to the surrounding decoration is avoided). If pattern or colour starts wearing off further away from the repair then you are sanding unevenly and/or pressing too hard. Any texture will be restored in the last stage of the process. FIG. 5 shows a mass 503 of the added material being sanded by sandpaper 502 under levelling block 501. The surface 503 is now flat, but in the illustration is not yet flush (coplanar) with the original surface 100. (The user should allow for some increase of thickness during colouring).

The next stage is to apply colour, pattern, and surface texture over the replaced mass so that the repair is effectively invisible.

PART 2: Restoration of Surface, With Respect to Texture and Colour.

This is also the starting point for any repair where the surface has not been penetrated, but the colour or pattern has been damaged. In principle this procedure comprises application of a selected mixture of pigment in a matching distribution of patterns, starting with a light base, then covering with a sprayed transparent surface coat (herein called “ProSeal”) capable of drying to a desired texture, and repeating the process with selected pigments and further layers of ProSeal until the surface appearance is a sufficiently close match to that of the surrounding, undamaged surface.

If the damaged area has a patterned finish the pattern is applied first and the texture is blended in afterwards (see below). If the damaged area has a plain colour finish the colour may be sprayed on with the ProSeal. Finally, at least one heavier layer of ProSeal is applied in order to protect the colouring from subsequent abrasion. It must be realised that there are many different patterns of decorative laminate on the market, with numerous effects and finishes. The ability to provide an exact duplication of any one pattern and finish requires a good deal of training and practice.

Part 2A; Preparation and Application of Colours.

Preferred Pigment Formulations.

A suitable pigment formulation (herein named “ProColour”) has (1) moderate covering power, so that it can conceal the underlying dark brown laminate yet the colour from a lower layer of pigment can influence a layer nearer the surface, (2) dries quickly, (3) dries to a minimal thickness, and (4) the colour when wet during application is very similar to the final colour when dry and under a varnish. The last requirement seems to exclude water-based pigments and necessitate the use of formulations based on organic solvents. Fade resistance is another desirable attribute and we intend to monitor repairs or at least any complaints over a period of years in order to learn which colouring materials are least likely to fade. Incidentally colour matching should be done with due recognition of colour balance in artificial versus natural lighting, and also noting that about 10% of male persons have some colour blindness.

We currently prefer that our “ProColour” material is a commercial leather or vinyl dye in which a pigment is suspended in a mixture of toluene, methyl ethyl ketone (MEK), and methyl iso-butyl ketone (MIBK). This is believed to be equivalent to “Fiebing's Acrylic Dye Pack-” including bottles of white, black, and nine other strong colours. It is convenient to make up, and carry in the kit of pigments a second set of light colours not provided in the original kit by mixing a little strong colour with white.

Leather dyes are available commercially including many other solvents/vehicles including water, alcohol, rubbing alcohol, acetone and the like. Further alternative colouring agents may be found preferable. For example both BASF (Germany) and Neomark (Taiwan) produce chromium complex dyestuffs which can be dissolved in a variety of solvents. Either of these products may require inclusion of a whitish opacifier in suspension. Incidentally, attempts to include a colouring material mixed into cyanoacrylate have so far resulted in interference with the polymerisation process and as a result the coloured mass stays soft.

For some situations, felt-tip pens, calligraphy pens, metallic ink markers, and the like are used creatively in order to achieve specific colour effects. For example a brown felt-tip pen is used to draw a brown line simulating a chamfered edge on a “Formica” bench repair.

Part 2B; Preparation and Application of Surface Covering Materials.

Preferred Textures-Variants of “ProSeal”.

See Table 1. These textures are of the “two-pot” type where type A and type B components are mixed well shortly before use. Hence the set of products made by Resene Santano provides six (three type A and two type B) combinations of texture and rate of cure, as well as a thinner. In all situations use two parts of part A components: ProMat, ProSatin or ProGloss and one part of part B: FastCure or SlowCure. Then a maximum of ProColour and/or ProThinner can be added up to ⅓of the total volume, using syringes to measure components. The Resene Santano products are much less viscous than alternatives so far obtained from the United States-those alternatives were too viscous for spraying. All the 4000 range is water-clear. Our terms ProMat, ProSatin, or ProGloss represent selections from that range (as given in Table 1). The ProThinner is usually added to alter the size of texture granularity to be created. (The strength of spraying also affects granularity).

### EXAMPLE 1

### Mottled Pattern: (with no strong colours)

This is the easiest type of pattern to match. Apply a drop of a selected ProColour composition to a pipe cleaner (an example of a brand which has cotton, not synthetic fibres). Pigment is applied with the pipe cleaner over the area to be re-coloured by gently dabbing in order to vary the intensity, amount and tone of the colours. By rubbing the pipe cleaner on newspaper, mixing until the desired tone is required, then dabbing on to the damaged area, the mottled effect will develop. FIG. 7 shows this process. The end 701 of the pipe cleaner is preferably bent back as shown. Pigment is thereby placed on the surface 702. A heavy push with minimal dye will have the effect of slightly altering tone or blending across two colours. A fine touch with a minimal amount of dye will give a fine dot. A heavy coating with a lot of dye will give a smudge effect. Slight brushing gives lines, etc.

When the pattern develops a user may find the colours are starting to smudge together too much so a coat of ProSeal should be applied to stabilise the pattern so far, and allow further colouring to be added over the coat once dried.

For very smooth texture or high gloss finish use an airbrush for application of ProSeal. For fine through to coarse texture we prefer to use a spray gun driven by a portable compressor, although we have previously used a mouth spray device which is not advisable with solvents. FIG. 8 shows a hand gun 801 for compressed air, with a spray 804 developed by a Venturi effect at the top of tube 803. The bottle 802 (which may have a rubber diaphragm as a seal) contains some mixed-together ProSeal at 806. The sprayed material arrives on the surface 805. Full pressure gives maximum spray but minimal sized texture grain. Lowering the pressure tends to increase the size of the texture grain.

Once the ProSeal is dry, spray a small amount of water over the area and give another lighter and more general rub down with preferably 240 grit wet and dry sandpaper. Apply the finishing touches to the patter. For a final coat to blend the repair in (matching the gloss, feel and texture of the rest of the bench) the inventor prefers to adjust the already mixed ProSeal to suit by adding another 2 ml of ProGloss and another 1 ml of SlowCure to the existing mixture. This will increase the shininess of the original coat, give a slower drying time and the lower percentage or absence of ProThinner will give a thicker mixture and result in a coarser texture when sprayed. Spray as before but back off the pressure as the material comes out.

On a mottled pattern, one coat of ProSeal is usually sufficient before fine-tuning the pattern and then applying a second, final coat of ProSeal. Note that the ProSeal (particularly the first coat) may slightly alter the tones of some colours. It is recommended to apply a coat of ProSeal before assuming the colour and the pattern is correct. The first application of ProSeal is also used to seal or hold the pattern and may be used for levelling out of the repair.

Usually after some colour reconstruction a flat spot develops where the pattern has been applied, surrounded by a shiny ring around the edge where there is excess of the ProSeal. In order to complete the repair, the area needs to dry and be sanded back to minimise these effects. Then farther coats of ProSeal are applied to blend in to the surrounding undamaged surface. To seal this pattern at this stage would require a fast drying product without too much gloss so as not to create a shiny spot. Usually this would be done at a later visit. Mix 2 ml of ProSatin with 1 ml of FastCure and add up to 1 ml of ProThinner to help the flow of the mixture through the spray gun.

### EXAMPLE 2

### Mottled Pattern: (high gloss, heavily textured, and definite colours).

This is the same process as above but to achieve the desired pattern the colours should usually be mixed separately to achieve the consistency required. Using the lid of a mixing pottle mix a small quantity of one of the desired colours. Do not worrying about getting the colour correct at the start, as above the repair has to blended across from the brown substrate and white background closer to the actual surface colour/s of the bench before it can be finally matched up. Apply with pipe cleaner as before and repeat with other colours. As soon as a general coverage across the dark brown and various colours has been achieved apply a thin coat of ProSeal with the FastCure. This will prevent smudging. Repeat as required until the pattern is matched up. Colours can always be altered as you progress continually getting closer (or further away) to what you want. Adjust the ProSeal to get the desired texture and gloss and apply as previously described.

### EXAMPLE 3

### Fleck Pattern: (very fine dots of definite colours).

As above, but it is more difficult to replicate the fine spots. Always use a few pieces of newspaper to set your gear out on and always test your colours and quantities on this before applying to the pattern. To help replicate fine fleck patterns use very light coats of ProSeal at regular intervals but with the SlowCure. As soon as this is tacky you can use the tackiness to <<pull>>the fine dots off your pipe cleaner and into the pattern. Another way to apply fine dots is by spraying a ProSeal with flecks suspended in it. These repairs will take longer periods of time to build the fine effect back in.

### EXAMPLE 4

### Plain Colour Surfaces

Colours can be mixed with and then applied together with the ProSeal as per the formulas described above. The proportion of colour must not exceed the limit, or the strength of the surface diminishes accordingly. Quicker, smoother coverage can be achieved if the airbrush is used right from the start in the application of the colour. Finer coats can be applied which will dry quicker.

In order to match a specific surface texture, make use of the texture applicator towards the end of the procedure. When replicating the texture with colour included in the ProSeal mixture the colour will act as a thinner and must be allowed for when looking for density of product to adjust the final texture.

Note that the techniques disclosed in this invention can be used for simply “repainting” an entire decorative laminate bench and simulating any pattern colour and texture, should the owner desire a change.

### EXAMPLE 5

### Scratched Surface

If the surface to be repaired is only scratched without the underlying pattern or colour being damaged then sometimes simply applying a coat or two of a ProSeal mix having a matching amount of gloss or texture (as described above) will make the scratch disappear.

The entire process may require several visits to the premises where the damaged surface is located. It will be appreciated that the process may require selections from a number of different containers of resins, colouring materials, and solvents, also sandpaper, a water spray, air brush and spraying equipment. There is also a need to carry rags and newspaper (or the like) for wiping up and cleaning away spilt materials. The inventor prefers to pack all his materials into a wheeled handcart for portability and convenience. The compressor is the only other large item to be carried.

Variations

The inventor receives requests for the service from (a) individuals who have burnt or impacted a laminated surface, (b) kitchen installers whose product received damage during building and/or installation, (c) renovators who for example have removed a cupboard support formerly screwed through the laminate, (d) property services people, and (e) people who simply want a new colour, possibly because the old bench has had the coloured layer worn away.

Variations which speed the drying or polymerisation process might be seen as beneficial; for example the use of ultra-violet initiated polymerisation. In the inventor's experience, UV polymerisable materials tend to crack and fail quickly although it is possible that an improved material will be located.

The filling material could be an epoxy resin or other two-part mixed resin including a urethane, an acrylic, or the like.

The inventor also uses the process with damaged bath surfaces (generally baths are made of an acrylic blend or laminated sheet) and shower tubs, and on occasion with non-plastics objects such as linoleum floors, ceramic tiles, and surfaces of wood. These surfaces are compatible with the materials used. On one occasion, a broken marble lamp was restored.

The procedure may be useful in restoration of objects by museums and art galleries, and where a facsimile of a precious or fragile object is to be made and then put on display by a museum.

Commercial Benefits or Advantages

The invention provides an inexpensive and readily applicable solution to the problem of repairing damaged surfaces without replacement of the entire damaged article.

The invention allows repair of any missing mass, copying of the surrounding (or other) colours, and also copying of the surface texture so that the site of damage is virtually invisible.

Heat damage of the replacement material occurs at a slightly lower temperature than the surrounding laminate-120 deg C. instead of 130 deg C.

Insurance companies usually prefer that the bench top be repaired rather than replaced, because repair is far cheaper.

Finally, it will be understood that the scope of this invention as described and/or illustrated within this specification is not limited to the preferred embodiments described herein for illustrative purposes. Those skilled in the art will appreciate that various modifications, additions, and substitutions are possible without departing from the scope and spirit of the invention as set forth in the following claims.

I claim:

1. A method for repair of a defect in a surface including replacement of lost or damaged mass (if any) and restoration of the visual appearance of the surface of the repaired defect so that a close match is obtained with an adjacent surface, characterised in that the method includes the stages of
a) removing the damaged material at least beneath the plane of the adjacent surface so that only undamaged material remains within the defect,
b) cutting a bevel around the outer edges of the debrided area,
c) filling the defect with a mass of a selected polymerisable material, until the surface of the mass protrudes slightly above the adjacent surface,
d) reducing the height of the surface of the filled defect so that the surface plane is slightly below the plane of the adjacent surface,
e) restoring the colour and pattern by repeatedly (i) applying at least one selected pigment in a similar colour and pattern to that of the adjacent surface over the filled defect, then (ii) spraying a selected sealing material over the pigment, until the colour and pattern are substantially matched, and
f) spraying a selected sealing material over the uppermost layer of pigment so that the texture of the repaired defect matches the texture of the adjacent surface.

2. A method as claimed in claim 1 characterised in that the mass of polymerisable material used to fill the defect comprises at least one layer of polymerised plastic.

3. A method as claimed in claim 2 characterised in that the polymerised plastic is a cyanoacrylate.

4. A method as claimed in claim 1 characterised in that the mass of polymerisable material used to fill the defect comprises a two-part putty.

5. A method as claimed in claim 1 characterised in that the selected pigment comprises a suspension of coloured particles in at least one organic solvent.

6. A method as claimed in claim 5 characterised in that the solvent includes toluene, methyl ethyl ketone, and methyl iso butyl ketone.

7. A method as claimed in claim 1 characterised in that the selected sealing material comprises a mixture of at least one selected polymerisable monomer having a known texture upon drying, and a selected polymerising agent conferring a known curing rate upon the mixture.

8. A method as claimed in claim 1 characterised in that the selected sealing material is applied by means of a spray gun driven by compressed gas.

9. A method as claimed in claim 1 characterised in that the selected pigment is taken up within a brush having a low holding capacity and applied to the surface of the filled defect by repeatedly touching the brush to the surface.

10. A kit of equipment characterised in that the equipment comprises tools and materials for use in performing the method as claimed in any previous claim.

11. A kit of equipment characterised in that the equipment comprises tools and materials for use in performing the method as claimed in claim 1.
